(19) United States
(12) Patent Application Publication
(10) Pub. No.: US 2017/0055518 A1
(43) Pub. Date: Mar. 2, 2017

(54) Game Calling Device Having Adjustable Sound and Method for Using

(71) Applicant: Hunters Specialties, Inc., Cedar Rapids, IA (US)

(72) Inventors: Scott Thomas, Marion, IA (US); Ron Bean, Cedar Rapids, IA (US); Jesse Kruska, Wallingford, CT (US); Garrett Fink, Glastonbury, CT (US); David Schweitzer, Weston, CT (US)

(73) Assignee: Hunters Specialties, Inc., Cedar Rapids, IA (US)

(21) Appl. No.: 15/248,234

(22) Filed: Aug. 26, 2016

Related U.S. Application Data
(60) Provisional application No. 62/210,805, filed on Aug. 27, 2015.

(51) Int. Cl. A01M 31/00

(52) U.S. Cl. CPC A01M 31/004

(57) ABSTRACT

An animal call device commonly referred to as a grunt tube. The grunt tube generally includes a housing, a reed, and an adjustment arm adapted to engage the reed. The adjustment arm is combined with a first portion of the grunt tube which may be one of either the outlet end, the housing, or the mouthpiece. The reed is combined with a second portion of the grunt tube which may be a different one of either the outlet end, the housing, or the mouthpiece. The first portion of the grunt tube moves relative to the second portion of the grunt tube thereby causing the adjustment arm to move relative to the reed and engage the reed at different locations to change the sound produced by the grunt tube.

### CROSS-REFERENCE TO RELATED APPLICATION

The present invention claims priority to Provisional Patent Application Ser. No. 62/210,805, filed Aug. 27, 2015, the disclosure of which is hereby expressly incorporated by reference.

### BACKGROUND

The present invention relates to game calling devices, and in particular, to an adjustable grunt tube that can produce sounds having varied pitch, intensity, tone and inflection.

Game calling devices for large mammals and predators are known. In particular, devices known as “grunt tubes” are used to simulate the grunts, snorts, bleats and other sounds produced by white-tailed deer. Hunters and wildlife enthusiasts use grunt tubes to attract deer and other animals.

Grunt tubes generally include a tubular member through which air passes and a reed supported within the tubular member. The passing air excites the reed causing it to vibrate and produce sounds. Some grunt tubes allow the user to vary the sounds produced by the calling device. In one existing device the sound is varied by adjusting the position of an o-ring along the length of the reed. One problem with this device is that the o-ring can be difficult for the user to access since the reed/o-ring assembly is positioned inside the central housing of the device. Another problem with this device is that it can be difficult for the o-ring to make contact all the way around the circumference of the reed which can hinder the reed's vibration and distort the sound. Yet another problem with this device is that the o-ring requires periodic lubrication to prevent it from drying out.

There is therefore a need for an improved grunt tube which overcomes these and other disadvantages in the prior art.

### SUMMARY

One aspect of the invention relates to an animal call device commonly referred to as a grunt tube. The grunt tube generally includes a housing, a reed, and an adjustment arm adapted to engage the reed. The adjustment arm is combined with a first portion of the grunt tube which may be one of either the outlet end, the housing, or the mouthpiece. The reed is combined with a second portion of the grunt tube which may be a different one of either the outlet end, the housing, or the mouthpiece. The first portion of the grunt tube moves relative to the second portion of the grunt tube thereby causing the adjustment arm to move relative to the reed and engage the reed at different locations to change the sound produced by the grunt tube.

Another aspect of the invention relates to an animal call device commonly referred to as a grunt tube. The animal call generally includes an elongated housing, a reed, and an adjustment member having an adjustment arm in frictional engagement with the reed. The housing includes a mouthpiece end that allows air to enter the tubular member, an outlet end that emits sounds, and an opening in a wall of the tubular member between the mouthpiece end and the outlet end. The reed is combined with the housing and vibrates in response to passing air and is disposed within the housing near the mouthpiece end and the opening. An adjustment assembly includes an adjustment member having an adjustment arm which contacts to the reed. A user can modify the sounds emanating from the outlet end by changing the position of the adjustment assembly along the length of the reed to change the vibrational characteristics of the reed. Some embodiments include an expandable member which is made from a flexible and, elastic material thereby allowing it to have a first position wherein it is nested inside the solid-body housing and a second position wherein a portion extends outside of the housing. In one embodiment the expandable member is biased in its first position so that it retracts inside the housing when the user no longer exerts a pulling force on the outlet end.

Another aspect of the invention relates to an animal call device commonly referred to as a grunt tube. The animal call generally includes an elongated housing, a reed, and an adjustment member having an adjustment arm in frictional engagement with the reed. The housing includes a mouthpiece end that allows air to enter the tubular member, an outlet end that emits sounds, and an opening in a wall of the tubular member between the mouthpiece end and the outlet end. The reed vibrates in response to passing air and is disposed within the housing near the mouthpiece end and the opening. The adjustment member is secured to the housing and has an adjustment arm which contacts to the reed. An adjustment assembly is slidably engaged with the housing and is combined with the reed at one end. A user can modify the sounds emanating from the outlet end by changing the position of the adjustment assembly (reed) relative to the adjustment member (adjustment arm) to change the vibrational characteristics of the reed. Some embodiments include an expandable member which is made from a flexible and elastic material thereby allowing it to have a first position wherein it is nested inside the solid-body housing and a second position wherein a portion extends outside of the housing. In one embodiment the expandable member is biased in its first position so that it retracts inside the housing when the user no longer exerts a pulling force on the outlet end.

Another aspect of the invention relates to a method of using an animal call. The animal call generally includes an elongated housing having, a mouthpiece end and an outlet end, a reed, and an adjustment member having an adjustment arm in frictional engagement with the reed. The method includes passing air into the mouthpiece end of the housing as is known in the art. The reed vibrates in response to the passing air to create an audible sound which is emitted from the outlet end of the device. In one embodiment the sound emanating from the outlet end is modified by changing the position of the adjustment arm along the length of the reed to change the vibrational characteristics of the reed. In another embodiment the sound emanating from the outlet end is modified by changing the point where the adjustment arm contacts the reed by changing the position of the reed relative to the stationary adjustment arm. Some embodiments include an expandable member. The expandable member has a first position wherein it is nested inside the housing and a second position wherein a portion extends outside of the housing. The expandable member is biased in its first position so that it retracts inside the solid-body housing when the user no longer exerts a pulling force on the outlet end. The expandable member may be moved to its extended position to increase the distance between the mouthpiece end and the outlet end which modifies the sound emitted. In its extended position the expandable member may be bent or flexed to modify the direction of sound emitted from the outlet end.

### BRIEF DESCRIPTION OF THE DRAWINGS

FIG. 1 is a side view of an embodiment of the grunt tube.

FIG. 2 is a perspective view of an embodiment of the grunt tube.

FIG. 3 is a side section view of an embodiment of the grunt tube showing the adjustment member in a first position along the length of the reed.

FIG. 4 is a side section view of an embodiment of the grunt tube showing the adjustment member in a second position along the length of the reed.

FIG. 5 is a side section view wherein the housing and mouthpiece have been removed to show the adjustment member, reed, and support member.

FIG. 6 is a side section view showing an embodiment having an expandable member, wherein the expandable member is in its retracted position.

FIG. 7 is a side section view showing an embodiment having an expandable member, wherein the expandable member is in its extended position.

FIG. 8 is a perspective view showing an embodiment wherein the opening in the outlet end approximates the size and shape of the housing.

FIG. 9 is a perspective view showing an embodiment wherein the size of the opening in the outlet end is reduced.

FIG. 9a is a front view of a plate member used to adjust the size of the outlet opening.

FIG. 9b is a front view of an alternate embodiment of a plate member used to adjust the size of the outlet opening.

FIG. 10a is a top view of an embodiment wherein the reed moves relative to the (stationary) adjustment arm and the alternate adjustment member is in a first (retracted) position.

FIG. 10b is a side view of the embodiment shown in FIG. 10a.

FIG. 10c is a section view of the embodiment shown in FIG. 10a.

FIG. 11a is a top view of the embodiment shown in FIG. 10a with the alternate adjustment member in a second (extended) position.

FIG. 11b is a side view of the embodiment shown in FIG. 11a.

FIG. 11c is a section view of the embodiment shown in FIG. 11a.

### DETAILED DESCRIPTION

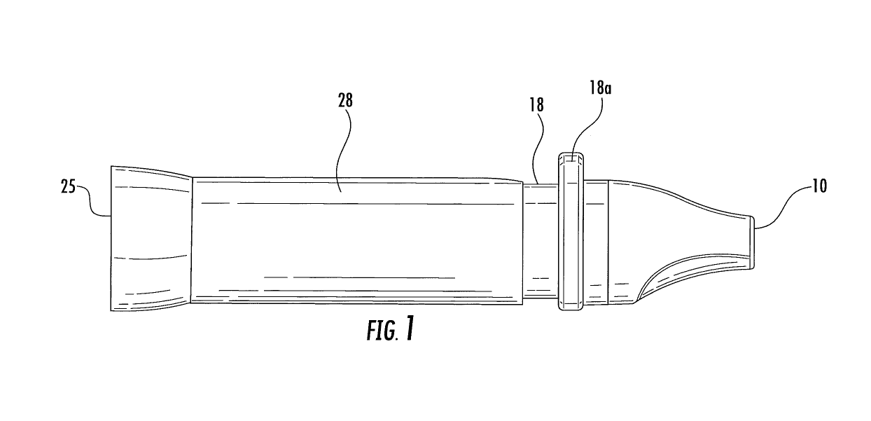

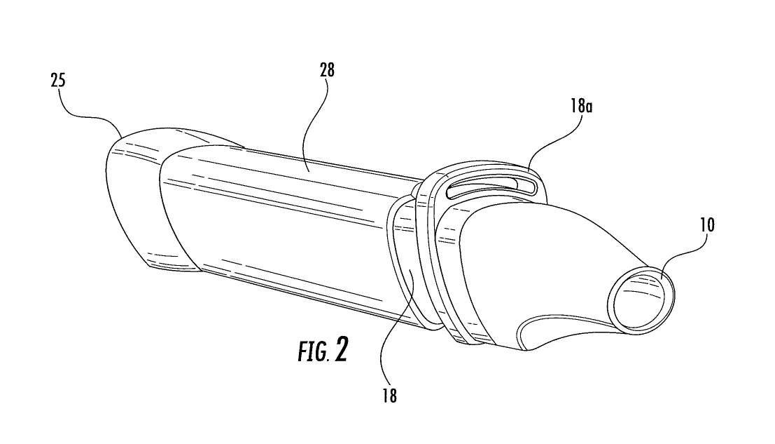

FIGS. 1 and 2 show a side view and a perspective view, respectively, of an embodiment of the grunt tube. The grunt tube generally includes a housing 28, a reed 12, and an adjustment arm 17 adapted to engage the reed 12. The adjustment arm 17 is combined with a first portion of the grunt tube which may be one of either the outlet 25 end, the housing 28, or the mouthpiece 10 end. The reed 12 is combined with a second portion of the grunt tube which may be a different one of either the outlet 25 end, the housing 28, or the mouthpiece 10 end. The first portion of the grunt tube moves relative to the second portion of the grunt, tube thereby causing the adjustment arm 17 to move relative to the reed 12 and engage the reed 12 at different locations. For convenience, this embodiment is shown and described as having the reed 12 combined with the housing 28 and the adjustment arm 17 combined with the mouthpiece 10 end which together comprise an adjustment member 18 that is slidably engaged with the housing 28 to modify the effective length of the reed 12 as described below in more detail. However, as mentioned above, the reed 12 and adjustment arm 17 may be combined with any of the different components that move relative to each other.

The mouthpiece 10 allows air to enter the housing 28 and pass through the adjustment member 18 to an outlet 25 at the other end which emits sounds. As used herein, “upstream” is toward the mouthpiece 10 and “downstream” is toward the outlet 25. An opening in a wall of the housing 28 extends between the mouthpiece 10 and the outlet 25 to allow air to pass through the length of the housing 28. The adjustment member 18 also has an opening which allows air to pass through the length of the adjustment member 18. The housing 28 has an inner surface and an outer surface and may be made of any suitable material. In one embodiment the housing 28 is made from a solid material such as hard plastic polymer. The housing 28 can be any suitable shape, including tubular and rectangular prism.

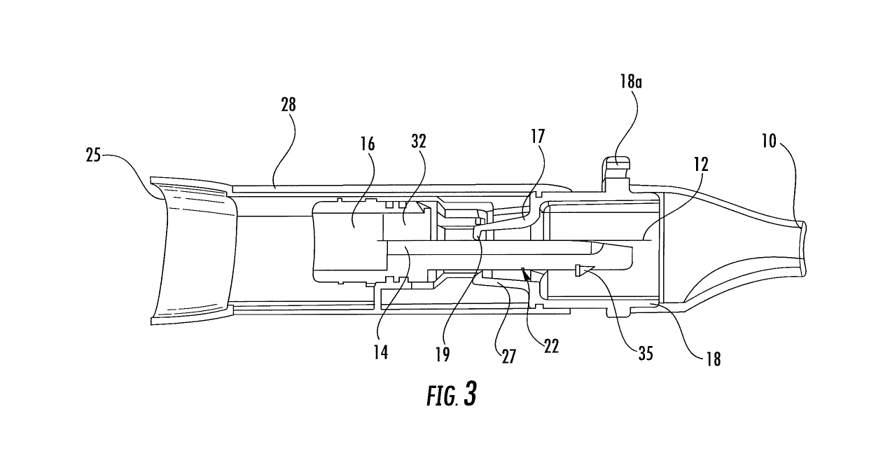

The reed 12 is disposed within the housing 28 in alignment with the mouthpiece 10 opening. The reed 12 is a thin strip of a flexible material, such as, e.g., plastic or MYLAR. As known in the art, the dimensions of the reed 12 and the material of which it is made are determined according to the sound characteristics that the user desires to produce with the grunt call. The reed 12 is supported by a sound board 14 (FIGS. 3-5) having at least a first and second side and a reed support member 16. In some embodiments the sound board 14 and support member 16 are molded together as one piece. A removable wedge 32 may be used to secure the reed 12 to the first side of the sound board 14. After the reed 12 is positioned adjacent to the sound board 14, the wedge 32 is placed on the downstream portion of the reed 12 and forced into an opening having a size and shape approximately the same as the wedge 32. The wedge 32 is frictionally secured in the opening to hold the reed 12 against the sound board 14. In some embodiments the opening or wedge 32 may be tapered so the friction between the wedge 32 and the walls of the opening increases as the wedge 32 is pushed farther into the opening. These or other components used to secure the reed 12 in place are sometimes referred to as the reed assembly.

In some embodiments, the length of the sound board 14 is shorter than the length of the reed 12 to help slow down the reed's 12 vibrations. In other embodiments the reed 12 is longer than the sound board 14. Depending upon the desired sound characteristics, however, different sound board 14 configurations can be used. The sound board 14 preferably includes an upstream end disposed adjacent the mouthpiece 10 which is tapered to be thinner than the downstream end thereby allowing the upstream portion of the reed 12 to be suspended away from the sound board 14. The reed 12 preferably includes an upstream end that is also disposed adjacent the mouthpiece 10 and a downstream end. The downstream end of the reed 12 is connected to the downstream end of the sound board 14 as described above. The upstream end of the reed 12 is free to vibrate away from the sound board 14, subject to the position of the adjustment member 18 as described below.

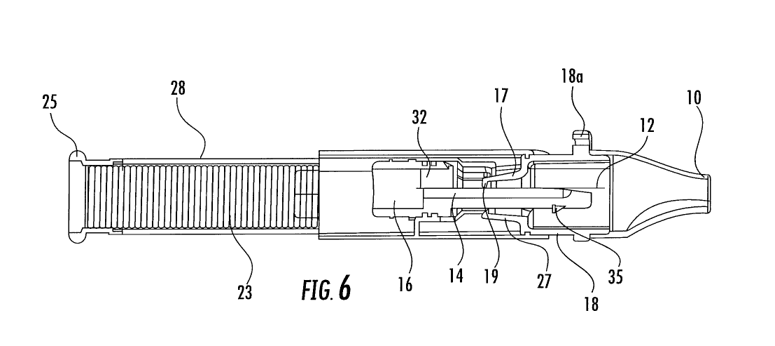

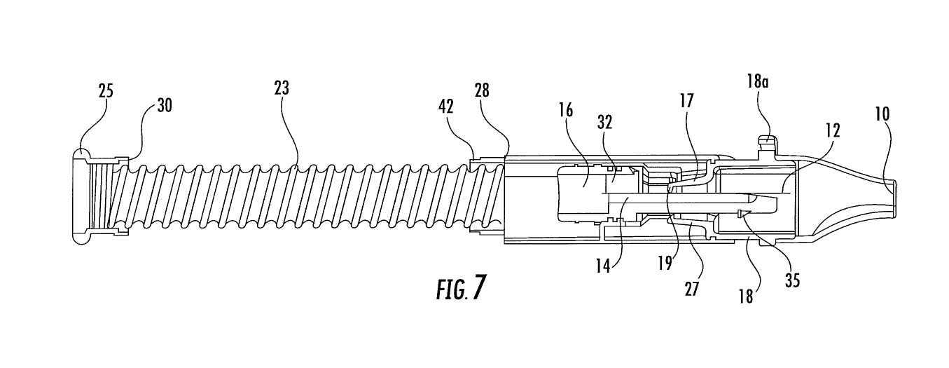

As shown in FIGS. 6-7, in some embodiments an expandable member 23 is combined with the housing 28. The expandable member 23 has an opening in a wall in fluid communication with the opening in the wall of the housing 28 to allow air to pass through the expandable member 23 as it passes between the mouthpiece 10 and the outlet end 25 The expandable member 23 may be any suitable shape, including tubular and rectangular prism. The shape of the expandable member 23 may be the same as the shape of the housing 28 to allow the outer surface of the expandable member 23 to be positioned against the internal surface of the housing 28. The expandable member 23 is made from a flexible and elastic material such as rubber. The expandable member 23 has a first position wherein it is retracted and a second position wherein it is extended. In some embodiments the expandable member 23 has an outer surface with a diameter smaller than the outer diameter of the housing 28 thereby allowing the expandable member 23 to be nested inside the housing 28 in its first position as shown in FIG. 6. In its second position at least a portion of the expandable member 23 is pulled outside of the housing 28 as shown in FIG. 7 such that the outer surface of the expandable member 23 is not within the housing 28. Extending the expandable member 23 to its second position increases the volume of the chamber downstream from the reed 12 by increasing the distance the air must travel between the mouthpiece 10 and the outlet 25. This increased chamber volume lowers the tone created by the animal call device. In some embodiments the expandable member 23 is biased in its first position so that it retracts inside the housing 28 when the user no longer exerts a pulling force on the outlet end 25.

A first end of the expandable member 23 is combined with any upstream portion of the animal call, preferably at a point immediately downstream from the reed 12. The second end of the expandable member 23 is combined with the outlet end 25 of the housing 28. The outlet end 25 is separable from the main housing member (the portion of the housing 28 between the outlet end 25 and the mouthpiece 10 is referred to herein as the main housing member). The upstream end of the outlet end 25 mates with the downstream end of the housing 28 when the expandable member 23 is in its first position. As shown in FIG. 7, in some embodiments the upstream portion of the expandable member 23 is combined with the housing 28 near the reed support member 16 and the downstream portion of the expandable member 23 is combined with the outlet end 25. In these embodiments the outlet end 25 is made from a hard material which may be the same material as the housing 28. The outlet end 25 has a lip or seat 30 which has a diameter larger than the diameter of the downstream end of the housing 28 so it is adapted to receive the rim 42 of the downstream end of the housing 28. When combined, the seat 30 and rim 42 form an airtight seal between the two components so they effectively function as one solid body. In another embodiment the upstream end of the outlet end 25 and the downstream end of the housing 28 are machine tapered to be self holding. In one embodiment the machine taper is a Morse taper. The biasing force of the expandable member 23 pulling the outlet end 25 toward the housing 28 causes the separate components 25, 28 to create a seal (FIG. 6) such that the entirety of the housing 28 and outlet end 25 function as a solid body grunt tube unless the user applies force to pull the outlet end 25 away from the housing 28 as shown in FIG. 7.

In an alternate embodiment at least a portion of the expandable member 23 is outside of the housing 28 even when the expandable member 23 is in its first (retracted) position. In this alternate embodiment the grunt call is not completely enclosed by a solid body housing when the expandable member 23 is in its first position.

The sounds produced by the grunt call can be varied in several ways. First, the user can partially or completely cover the outlet end 25 to change the pitch. Second, the length of the device may be varied by extending or retracting the expandable member 23 to change the length of the internal opening to change the pitch. The flexibility of the expandable member 23 also allows the direction of the sound to be varied by flexing or bending the expandable member 23 when it is in its extended position so the outlet end 25 directs sound in a direction other than along the longitudinal axis of the animal call. Third, the user can invert the grunt call and produce different sounds by inhaling through the outlet end 25 of the call instead of exhaling through the mouthpiece 10.

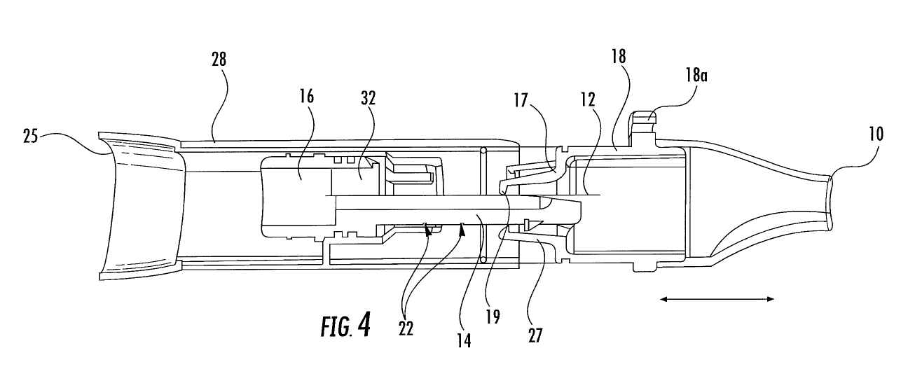

Another way to vary the sound of the call is to change the effective length of the reed 12 by moving a first portion of the grunt tube relative to a second portion of the grunt tube. As described above, in one embodiment the adjustment arm 17 is combined with the mouth piece 10 to form an adjustment member 18 which moves longitudinally relative to the housing 28 as shown by the arrow in FIG. 4. In some embodiments the adjustment arm 17 and the mouth piece 10 are formed together as a single member. The adjustment member 18 may include a gripping member 18a on the outside of the device for the user to grasp when moving the adjustment member 18 relative to the housing 28. In some embodiments the gripping member 18a has an opening adapted to receive a lanyard to allow the user to easily carry the device around his/her neck.

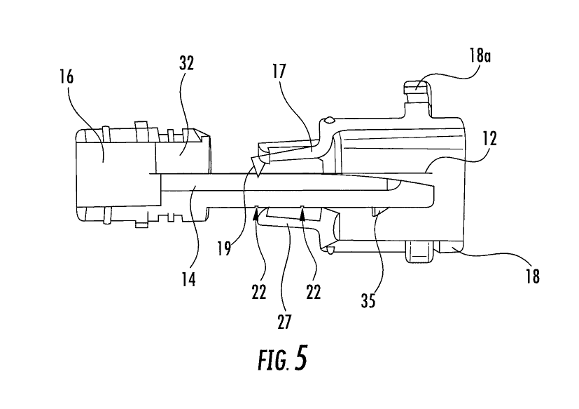

In the embodiment shown, the adjustment member 18 has an external diameter smaller than the internal diameter of the adjoining housing 28 portion to allow the adjustment member 18 to slide in and out of the housing 28. As shown best in FIG. 5, the adjustment arm 17 extends from the adjustment member 18 into the internal opening of the device toward the reed 12. The adjustment arm 17 has a contact end 19 which frictionally engages the reed 12 and presses the reed 12 against the sound board 14. Moving the mouth piece 10 longitudinally (in or out of the housing 28) effectively provides infinite adjustment of the contact end 19 along the length of the reed 12. In one embodiment the adjustment arm 17 is a curved rigid resilient member having a first position, wherein the arm 17 is lax and a second position wherein the arm 17 is compressed. The arm 17 is biased in its lax position. The adjustment member 18 is combined with the housing 28 such that the arm 17 is compressed against the reed 12. The resiliency of the arm 17 trying to return to its lax position exerts force against the reed 12 to change the effective length of the reed 12 (the vibrating portion of the reed 12 upstream from the arm 17).

In an alternate embodiment (not shown) the adjustment member 18 has an internal diameter larger than the external diameter of the adjoining housing 28 portion thereby allowing the housing 28 to slide in and out of the adjustment member 18. In this alternate embodiment the housing 28 has elongated openings adapted to receive the adjustment arm 17 and locating arm 27. These openings allow the adjustment arm 17 to extend toward the reed 12 and the locating arm 27 to extend toward the sound board 14 while the adjustment member 18 slides along the outside of the housing 28.

The user can adjust the effective length of the reed 12 by moving the adjustment member 18 longitudinally (in or out of the housing 28) which changes the point at which the contact end 19 engages the reed 12. In FIG. 3 the adjustment member 18 is shown in a first position wherein a certain length of the reed 12 (between the contact end 19 and the upstream end of the reed 12) is allowed to vibrate. In FIG. 4 the adjustment member 18 is shown in a second position wherein a shorter length of reed 12 is allowed to vibrate.

In some embodiments the sound board 14 includes one or more stop points 22 (FIG. 3) which may be ridges elevated above the surface of the sound board 14 or grooves indented below the surface of the sound board 14. The stop points 22 are located at predetermined positions along the length of the sound board 14. These predetermined positions allow a certain length of reed 12 to vibrate causing a known pitch or sound which may be useful for the user. The stop points 22 create an increased amount of friction between a portion of the adjustment member 18 and the stop point 22 which can be felt by the user as the adjustment member 18 is moved along the length of the housing 28 to signal the position of the stop points 22. As shown best in FIGS. 3-5, the adjustment member 18 assembly may further include a locating arm 27 which is similar to adjustment arm 17 but positioned to engage a different side of the sound board 14. As shown, the locating arm 27 extends from the adjustment member 18 on the opposite (second) side of the sound board 14 and is adapted to exert a biasing force against the second side of the sound board 14. In this embodiment the stop points 22 are positioned on the second side of the sound board 14 such that the head of the locating arm 27 is adapted to interfere with the stop points 22 as the adjustment member 18 is moved relative to the sound board 14 to create additional friction which causes the user to stop moving the adjustment member 18/mouth piece 10 when the locating arm 27 encounters a stop point 22. In addition, the outside of the housing 28 may include a visual marking to denote predetermined positions of the adjustment member 18. The visual markings may align with the position of the stop points 22 or they may be independent from the position of the stop points 22.

Some embodiments may include a stop member 35 to limit the distance that the adjustment member 18 may be extended outward away from the housing 28. As shown best in FIG. 5, the stop member 35 may be a protruding lip or ridge extending from the upstream end of the second side of the adjustment member 18. The locating arm 27 contacts the stop member 25 after the user pulls the adjustment member 18a maximum distance away from the housing 28. At this point the stop member prevents the locating arm 27 from passing over it, thereby preventing the user from extending the adjustment member 18 any further which could cause the components to separate from the housing 28.

In some embodiments at least a portion of the housing 28 is covered by a soft skin such as an elastic or synthetic or natural rubber. The skin material has a non-reflective matte black finish. In addition to reducing reflections, the rubber material also minimizes any sounds produced by incidental contact between the grunt call and other objects, such as, e.g., a hunter's weapon.

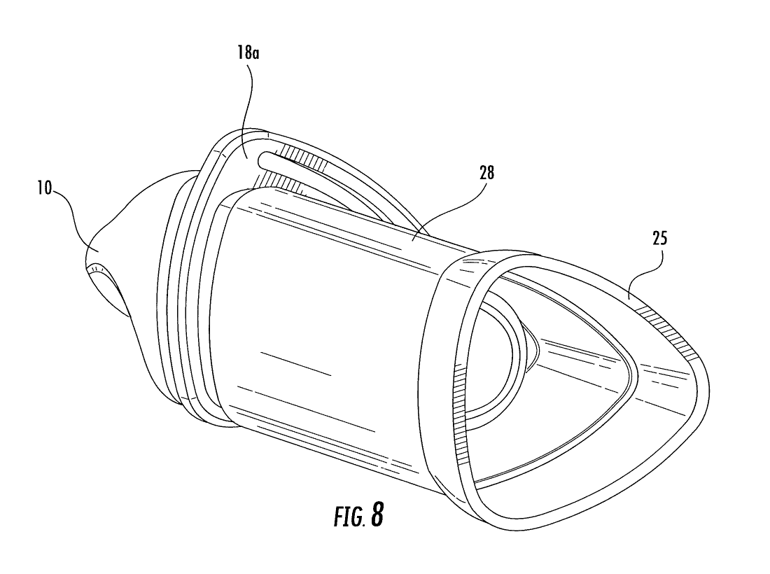

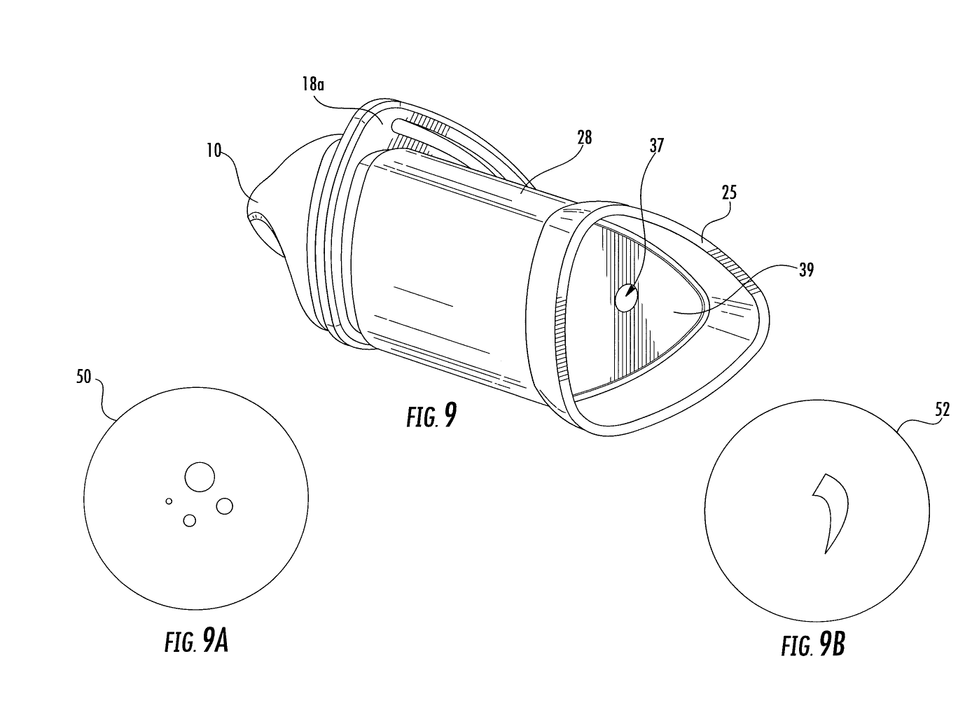

FIG. 8 shows a perspective view of the animal call wherein the outlet end 25 has an opening which approximates the size and shape of the housing 28. FIG. 9 shows a similar perspective view of a different embodiment wherein the size of the opening in the outlet end 25 is reduced by a partial wall 39 having a smaller opening 37 to restrict the rate at which air and sound leave a chamber created downstream of the reed 12 and upstream from the wall 39. The longer residence time of the sound waves in the chamber helps to create a deeper sound. In one embodiment the size of the opening 37 is smaller than the cross sectional area of the housing 28 and is adjustable by the user. In this embodiment the opening 37 may be adjusted to be larger for a higher tone and smaller for a deeper tone. In one embodiment the size of the opening 37 is controlled by a means similar to an iris diaphragm in a camera wherein actuation by the user (such as rotation of a portion of the device) causes a plurality of blades to move between a smaller (or closed) opening and a larger opening. In another embodiment a member 50 such as a thin plate as shown in FIG. 9a is rotatably combined with the device near the opening 37 so the plate 50 is adjacent the wall through which the opening 37 passes. The plate 50 has one or more openings of varying sizes. The plate 50 can be rotated so that openings of different sizes in the plate 50 align with the opening 37 at different times so the user can adjust the size of the opening 37 by adjusting the position of the plate 50. The opening 37 and the pivot axis of the plate 50 may be off center with respect to the other so that rotating the plate 50 causes its different openings to align with the opening 37. In another embodiment a member 52 such as a thin plate as shown in FIG. 9b is rotatably combined with the device near the opening 37 so the plate 52 is adjacent the wall through which the opening 37 passes. The plate 52 has a single triangular or spiral shaped opening having a varying height along its length. The plate can be rotated so that different the height of the opening in the plate 52 aligns with the opening 37 so the user can adjust the size of the opening 37 by adjusting the position of the plate 52. The opening 37 and the pivot axis of the plate 52 may be off center with respect to the other so that rotating the plate 52 causes its different heights to align with the opening 37.

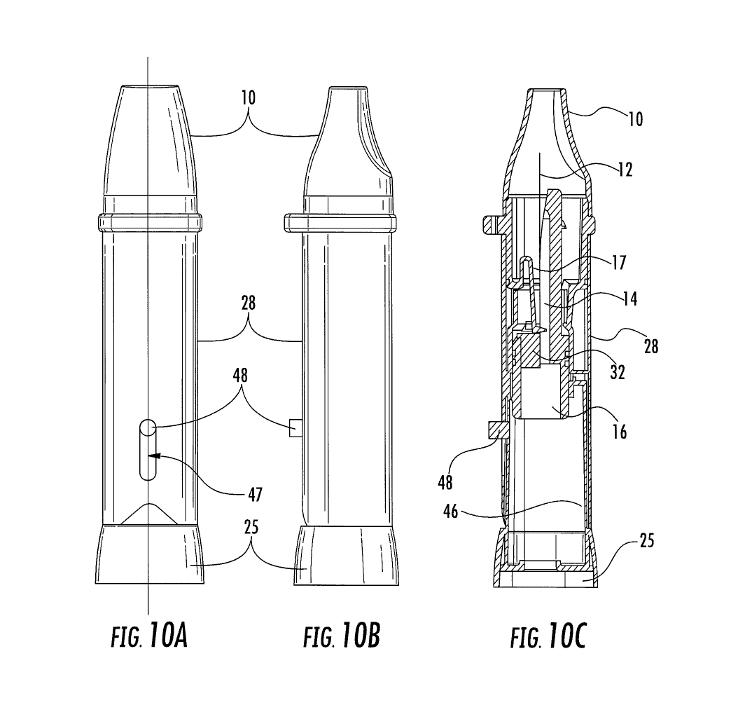

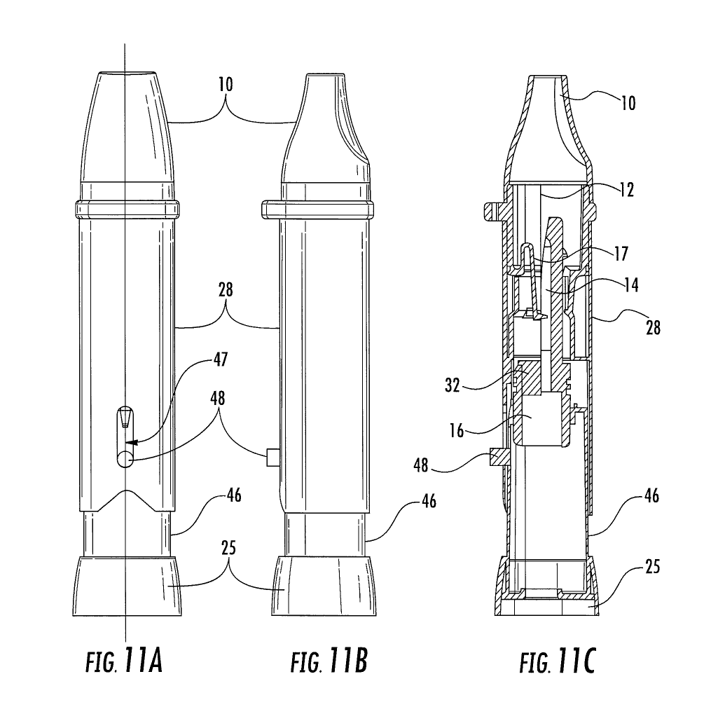

FIGS. 10a-10c and 11a-11c show an alternate embodiment wherein the adjustment arm 17 is secured to the inner surface of the housing 28. The device includes an alternate adjustment member 46 combined with either the outlet 25 end or the mouthpiece 10 end and movable relative to the housing 28. For convenience, this embodiment is shown and described as having the alternate adjustment member 46 combined with the outlet 25 end. The alternate adjustment member 46 is combined with the reed 12 assembly to form an adjustment assembly which is slidably engaged with the housing 28 to move the reed 12 relative to the adjustment arm 17 to modify the effective length of the reed 12.

FIGS. 10a, 10b, and 10c show the device with the alternate adjustment member 46 in its retracted position and FIGS. 11a, 11b, and 11c show the device with the alternate adjustment member 46 in its extended position. In its extended position the device is lengthened which increases the volume of the chamber downstream from the reed 12. This increased chamber volume lowers the tone created by the animal call device.

As shown in FIGS. 10a and 11a, the housing 28 has an elongated opening 47 adapted to receive a member 48. The member 48 is combined with the alternate adjustment member 46 so that movement of the alternate adjustment member 46 relative to the housing 28 causes the member 48 to travel within the opening 47. The member 48 helps keep the housing 28 and the alternate adjustment member 46 from becoming detached by limiting the distance the alternate adjustment member 46 can travel.

To use the device a user passes air into the mouthpiece 10 end of the housing 28 as is known in the art. The reed 12 vibrates in response to the passing air to create an audible sound which is emitted from the outlet 25 end of the device. The reed 12 is secured to a sound board 14 by placing the reed 12 on the sound board 14 then placing a wedge 32 on top of the reed 12 and into an opening where the wedge 32 is frictionally secured by the walls of the opening. The reed 12 is sandwiched between the wedge 32 and the support member 16 and/or sound board 14. The sound emanating from the outlet 25 end is modified by moving the adjustment assembly to change the vibrational characteristics of the reed 12. In one embodiment the adjustment assembly is combined with the adjustment arm 17 to move the adjustment arm 17 relative to the reed 12. In another embodiment the adjustment assembly is combined with the reed 12 assembly to move the reed 12 assembly relative to the adjustment arm 17. The user may move the adjustment assembly to certain predetermined stop points 22 along the length of the sound board 14. The expandable member 23 has a first position wherein it is nested inside the housing 28 and a second position wherein a portion extends outside of the housing 28. The expandable member 23 is biased in its first position so that it retracts inside the housing 28 when the user no longer exerts a pulling force on the outlet 25 end. The expandable member 23 may be moved to its extended position to increase the distance between the mouthpiece 10 end and the outlet 25 end which modifies the sound emitted. In its extended position the user may bend or flex the expandable member 23 to modify the direction of sound emitted from the outlet 25 end.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. An animal call comprising:
a first portion slidably combined with a second portion;
a reed combined with the first portion, wherein the reed is adapted to vibrate in response to passing air; and
an adjustment arm combined with the second portion, said adjustment arm in frictional engagement with the reed and adapted move relative to the reed as the first portion moves relative to the second portion.

2. The animal call of claim 1 wherein the first portion is one of an outlet end, a housing, and a mouthpiece.

3. The animal call of claim 1 wherein the second portion is one of an outlet end, a housing, and a mouthpiece.

4. The animal call of claim 1 further comprising a chamber formed downstream from the reed and upstream from a wall having an opening near the outlet end.

5. The animal call of claim 4 wherein the opening in the wall has a size that is less than a cross sectional area of the housing and the size of the opening is adjustable.

6. An animal call comprising:
a housing, a mouthpiece, an outlet end, and an opening in a wall of the housing between the mouthpiece and the outlet end, wherein one of the mouthpiece and the outlet end are movably combined with the housing between a first position and a second position;
a reed that vibrates in response to passing air, said reed being disposed within the opening of the housing and combined with one of the mouthpiece, the outlet end, and the housing; and
an adjustment arm combined with another one of the mouthpiece, the outlet end, and the housing, said adjustment arm in frictional engagement with the reed and adapted to slide along the length of the reed as the animal call is moved from the first position to the second position to change the effective length of the reed.

7. The animal call of claim 6 further comprising a chamber formed downstream from the reed and upstream from a wall having an opening near the outlet end.

8. The animal call of claim 7 wherein the opening in the wall has a size that is less than a cross sectional area of the housing and the size of the opening is adjustable.

9. An animal call comprising:
a mouthpiece;
a housing slidably engaged with the mouthpiece and having an outlet end, and an opening in a wall of the housing between the mouthpiece and the outlet end;
a sound board combined with the housing;
a reed disposed within said opening and supported by the sound board, wherein the reed is adapted to vibrate in response to passing air; and
an adjustment arm combined with the mouthpiece, said adjustment arm in frictional engagement with the reed and adapted move relative to the reed as the mouthpiece and housing move relative to each other.

10. The animal call of claim 9 wherein the sound board has a width larger than a width of the reed.

11. The animal call of claim 10 wherein the sound board includes one or more stop points.

12. The animal call of claim 11 wherein the sound board has an outer edge extending beyond the width of the reed and the stop points are on the outer edge.

13. The animal call of claim 11 wherein the stop points are elevated above a surface of the sound board.

14. The animal call of claim 10 wherein the adjustment arm exerts a biasing force to press the reed against the sound board.

15. An animal call comprising:
a housing, a mouthpiece, an outlet end, and an opening in a wall of the housing between the mouthpiece and the outlet end, wherein one of the mouthpiece and the outlet end are movably combined with the housing between a first position and a second position;
a reed that vibrates in response to passing air, said reed being disposed within the opening of the housing and combined with one of the mouthpiece, the outlet end, and the housing;
an adjustment arm combined with another one of the mouthpiece, the outlet end, and the housing, said adjustment arm in frictional engagement with the reed and adapted to slide along the length of the reed as the animal call is moved from the first position to the second position to change the effective length of the reed; and
an expandable member having a first position and a second position, in the first position at least a portion of the expandable member is nested inside the housing and in the second position at least a portion of the expandable member extends outside of the housing.

16. The animal call of claim 15 wherein the expandable member is biased in the first position.

17. The animal call of claim 15 wherein the expandable member has a first end combined with an upstream portion of the animal call and a second end combined with the outlet end, wherein the outlet end is separated from the main housing member when the expandable member is in the second position.

18. The animal call of claim 17 wherein the outlet end has a seat adapted to receive a rim portion of the main housing member to create a seal when the expandable member is in the first position.

19. The animal call of claim 15 wherein the expandable member is bendable.

20. The animal call of claim 15 wherein the elongated housing is made from a solid material such as hard plastic polymer.

21. The animal call of claim 11 wherein there is a first distance between the mouthpiece and the outlet end when the expandable member is in the first position and a second distance between the mouthpiece and the outlet end when the expandable member is in the second position, and wherein the second distance is longer than the first distance.

22. A method of using an animal call to produce a sound, said method comprising:
taking an animal call having a first portion slidably combined with a second portion,
a reed combined with the first portion, and an adjustment arm combined with the second portion, said adjustment arm in frictional engagement with the reed and adapted move relative to the reed as the first portion moves relative to the second portion;
conveying air past said reed, thereby causing said reed to vibrate and to produce sounds; and
moving the first portion relative to the second portion causing the adjustment arm to move from a first location against the reed to a second location against the reed to modify the sound.

23. The method of claim 22 wherein the animal call further comprises an expandable member having a first end combined with an upstream portion of the animal call and a second end combined with the outlet end and the method further comprises moving the expandable member from a first position where it is nested inside the elongated housing to a second position, where at least a portion of the expandable member extends outside of the elongated housing.
